(19) United States
(12) Patent Application Publication
(10) Pub. No.: US 2024/0121626 A1
(43) Pub. Date: Apr. 11, 2024

(54) SSB-LESS OPERATION FOR INTER-BAND CARRIER AGGREGATION

(71) Applicant: QUALCOMM Incorporated, San Diego, CA (US)

(72) Inventors: Konstantinos Dimou, New York, NY (US); Changhwan Park, San Diego, CA (US); Ruhua He, San Diego, CA (US); Sumant Jayaraman Iyer, San Diego, CA (US); Jianghong Luo, Skillman, NJ (US)

(21) Appl. No.: 18/483,314

(22) Filed: Oct. 9, 2023

Related U.S. Application Data
(60) Provisional application No. 63/378,964, filed on Oct. 10, 2022.

(51) Int. Cl. H04W 16/28; H04W 52/52

(52) U.S. Cl. CPC H04W 16/28; H04W 52/52

(57) ABSTRACT

A user equipment (UE) may transmit, to a primary cell, an indication of a capability to synchronize with a secondary cell based on measurements of the primary cell. A UE may estimate a propagation delay (tₚ) and an angle of arrival (AoA) of the secondary cell based on a synchronization signal block (SSB) or a channel state information reference signal (CSI-RS) transmitted by the primary cell. A UE may perform automatic gain control (AGC), fine timing synchronization, and fine frequency synchronization of the secondary cell based on a temporary aperiodic tracking reference signal (A-TRS) transmitted by the secondary cell. A UE may perform a receive beam sweep on a burst of a CSI-RS transmitted by the secondary cell, wherein a range of the receive beam sweep is based on the estimated AoA.

### CROSS-REFERENCE TO RELATED APPLICATIONS

This application claims priority to U.S. Provisional Application No. 63/378,964 titled “SSB-LESS OPERATION FOR INTER-BAND CARRIER AGGREGATION,” filed Oct. 10, 2022, which is assigned to the assignee hereof, and incorporated herein by reference in its entirety.

### TECHNICAL FIELD

The present disclosure relates to wireless communications, and more particularly to synchronization signal block (SSB)-less operation for inter-band carrier aggregation (CA).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to a method of wireless communication for a user equipment (UE), including transmitting, to a primary cell, an indication of a capability to synchronize with a secondary cell based on measurements of the primary cell. The method includes estimating a propagation delay (tₚ) and an angle of arrival (AoA) of the secondary cell based on a synchronization signal block (SSB) or a channel state information reference signal (CSI-RS) transmitted by the primary cell. The method includes performing automatic gain control (AGC), fine timing synchronization, and fine frequency synchronization of the secondary cell based on a temporary aperiodic tracking reference signal (A-TRS) transmitted by the secondary cell. The method includes performing a receive beam sweep on a burst of a CSI-RS transmitted by the secondary cell, wherein a range of the receive beam sweep is based on the estimated AoA.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

One innovative aspect of the subject matter described in this disclosure can be implemented in a method of wireless communication at a base station (BS) including: receiving, from a UE, an indication of a capability to synchronize with a secondary cell based on measurements of a primary cell co-located with the secondary cell at the base station. The method includes transmitting a SSB or a CSI-RS from the primary cell. The method includes transmitting a MAC-CE configured to activate the secondary cell. The method includes transmitting a temporary A-TRS from the secondary cell for timing and frequency acquisition by the UE, wherein a timing of the temporary A-TRS is based on an interruption window following an acknowledgment of the MAC-CE and a timing error (t_{ε}) between the primary cell and the secondary cell. The method includes transmitting a burst of a CSI-RS with repetition on a same beam from the secondary cell for receive beam acquisition by the UE.

The present disclosure also provides an apparatus (e.g., a BS) including a memory storing computer-executable instructions and at least one processor configured to execute the computer-executable instructions to perform the above method, an apparatus including means for performing the above method, and a non-transitory computer-readable medium storing computer-executable instructions for performing the above method.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 shows a diagram illustrating an example disaggregated base station architecture.

FIG. 5 is a diagram illustrating an example of beam squinting in inter-band carrier aggregation.

FIG. 6 is a diagram illustrating a first example procedure for synchronization with a synchronization signal block (SSB)-less secondary cell.

FIG. 7 is a diagram illustrating a second example procedure for synchronization with a SSB-less secondary cell.

FIG. 8 is a diagram illustrating a third example procedure for synchronization with a SSB-less secondary cell.

FIG. 9 is a message diagram illustrating example messages between a base station and a UE.

FIG. 10 is a conceptual data flow diagram illustrating the data flow between different means/components in an example base station.

FIG. 11 is a conceptual data flow diagram illustrating the data flow between different means/components in an example UE.

FIG. 12 is a flowchart of an example method for a UE to synchronize with a secondary cell in inter-band carrier aggregation.

FIG. 13 is a flowchart of an example method for a base station to configure a UE with inter-band carrier aggregation.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In wireless communications, beamforming may be used to compensate for power loss in communication between a transmitter and receiver. For example, in millimeter wave (mmW or mmWave) communications, the frequency may be relatively high compared to conventional communication channels and signal attenuation may be relatively large. However, due to the uncertain nature of a wireless environment and unexpected blocking, a beam may be vulnerable to beam failure. Techniques for beam management seek to select appropriate beams for communication and quickly select a different beam in the event of beam failure.

In some implementations, three levels of beam management are used with various selection processes. For example, a first level P1, is used to enable UE measurement of different (wide) TRP Tx beams to support selection of TRP Tx beams or UE Rx beams. Beamforming at the TRP typically includes an intra/inter-TRP Tx beam sweep from a set of different beams. Beamforming at the UE typically includes a UE Rx beam sweep from a set of different beams. For example, the UE identifies and reports the best SSB/CSI-RS together with a corresponding L1-RSRP (including also identifying the associated Rx beam), based on measurements of an SSB Burst Set or a P-CSI-RS Resource Set. A second level P2 is used to enable UE measurement on different (narrow) TRP Tx beams to possibly change inter/intra-TRP Tx beams. P2 processing may be performed on a possibly smaller set of beams for beam refinement than in P1. For example, abase station may beamform some UE-specific CSI-RS resources, which are narrow beams super-positioned w/the SSB that the UE reported in P1. The UE may further identify and report the best CSI-RS resource together a corresponding L1-RSRP (including also identifying the associated Rx beam), based on measurements of the CSI-RS resources. In some implementations, P2 can be considered a special case of P1. P3 is used to enable UE measurement on the same (narrow) TRP Tx beam to change UE Rx beam in the case UE uses beamforming.

One proposal to save power in a wireless communication system is to forego a separate SSB in a secondary cell in carrier aggregation. Such a secondary cell may be referred to as an SSB-less SCell. Generally, in SSB-less carrier aggregation, a UE may synchronize to the SSB-less SCell based on the SSB on the primary cell (PCell). Carrier aggregation may include intra-band CA, where all of the cells operate on a same frequency band, and inter-band CA, where at least one SCell operates on a different frequency band than the PCell. In an aspect, intra-band CA with SSB-less cells may be relatively straight-forward.

In contrast, inter-band CA with SSB-less cells raises several issues for the UE to synchronize with the SSB-less SCell. For example, the difference in frequency between the PCell and the SCell may cause difficulties for frequency and time synchronization of the SCell. Further, when the PCell and SCell use the same reference signal for beam management, beam squinting may cause the SSB-less cell to steer away from the UE such that the SCell is received with less power.

In an aspect, inter-band CA with SSB-less SCells may be limited to certain scenarios. In some implementations, only co-located cells using the same hardware may support inter-band CA with SSB-less SCells. For example, inter-band CA with SSB-less SCells may have a maximum limit on the frequency separation between the frequency bands to allow for similar propagation conditions. As another example, inter-band CA with SSB-less SCells may have a maximum receive time difference between the carriers of 3 microsecond (μs) for example. Further, not all UEs may be able to support inter-band CA with SSB-less SCells, so UEs that support inter-band CA with SSB-less SCells may signal a capability to support this feature, which may include specific requirements.

In an aspect, the present disclosure provides techniques for synchronizing a UE with an SSB-less SCell in inter-band CA. The UE may transmit, to the PCell, an indication of a capability to synchronize with the SCell based on measurements of the PCell. For example, the UE may estimate a propagation delay and an angle of arrival of the SCell based on an SSB or CSI-RS transmitted by the primary cell. A base station where the PCell and SCell are co-located, may determine to activate the SSB-less SCell and transmit a media access control (MAC) control element (CE) that activates the SSB-less SCell. The UE may receive the MAC-CE and transmit an acknowledgment to the PCell. Because the SCell is in a different band than the PCell, there may be an interruption window (e.g., 3 ms) before the SCell is activated. The base station may perform MAC processing during the interruption window, and the UE may tune RF components for the different band. After the interruption window, the base station may transmit a temporary aperiodic tracking reference signal (A-TRS). The UE may use the A-TRS for automatic gain control (ACG), fine timing acquisition, and fine frequency acquisition of the SCell cell. The UE may also perform a receive beam sweep (e.g., P3 beam refinement) on a burst of a CSI-RS transmitted by the secondary cell. The receive beam sweep may be limited to a range based on the estimated angle of arrival for the PCell.

Particular implementations of the subject matter described in this disclosure can be implemented to realize one or more of the following potential advantages. The base station may conserve power by foregoing transmission of an SSB on the SCell. UE performance may be improved for such SSB-less cells using temporary reference signals to improve the synchronization between the UE and the SSB-less cell. Further, the techniques disclosed herein may speed up cell acquisition of an SCell even when the SCell does transmit SSB.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media excludes transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

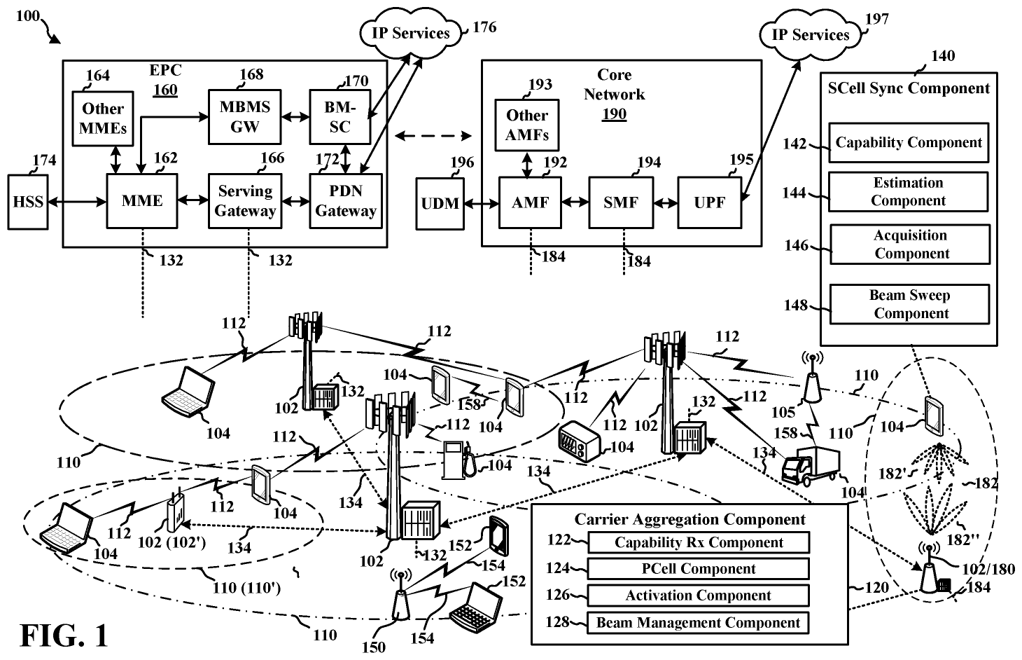

FIG. 1 is a diagram illustrating an example of a wireless communications system and an access network 100. The wireless communications system (also referred to as a wireless wide area network (WWAN)) includes base stations 102, UEs 104, relay devices 105, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU). The base stations 102 may be generically referred to as network entities.

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some implementations, one or more of the UEs 104 may include a SCell sync component 140 configured to synchronize the UE 104 with an SCell, which may include an SSB-less SCell. The SCell sync component 140 may include a capability component 142 configured to transmit, to a primary cell, an indication of a capability to synchronize with a secondary cell based on measurements of the primary cell. The SCell sync component 140 may include an estimation component 144 configured to estimate a propagation delay (tₚ) and an angle of arrival (AoA) of the secondary cell based on a synchronization signal block (SSB) or a channel state information reference signal (CSI-RS) transmitted by the primary cell. The SCell sync component 140 may include an acquisition component 146 configured to perform automatic gain control (AGC), fine timing acquisition, and fine frequency acquisition of the secondary cell based on a temporary aperiodic tracking reference signal (A-TRS) transmitted by the secondary cell. The SCell sync component 140 may include a beam sweep component 148 configured to perform a receive beam sweep on a burst of a CSI-RS transmitted by the secondary cell. A range of the receive beam sweep is based on the estimated AoA.

In some implementations, one or more of the base stations 102 may include a carrier aggregation component 120 configured to activate a SCell for carrier aggregation with a PCell. The SCell may be an SSB-less cell. The carrier aggregation component 120 may include a capability receiving (Rx) component 122 configured to receive, from a user equipment (UE), an indication of a capability to synchronize with a secondary cell based on measurements of a primary cell co-located with the secondary cell at the base station. The carrier aggregation component 120 may include a PCell component 124 configured to transmit a synchronization signal block (SSB) or a channel state information reference signal (CSI-RS) from the primary cell. The carrier aggregation component 120 may include an activation component 126 configured to transmit a media access control (MAC) control element (CE) configured to activate the secondary cell. The carrier aggregation component 120 may include a beam management component 128 configured to transmit a burst of a CSI-RS with repetition on a same beam from the secondary cell for receive beam acquisition by the UE.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other.

Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

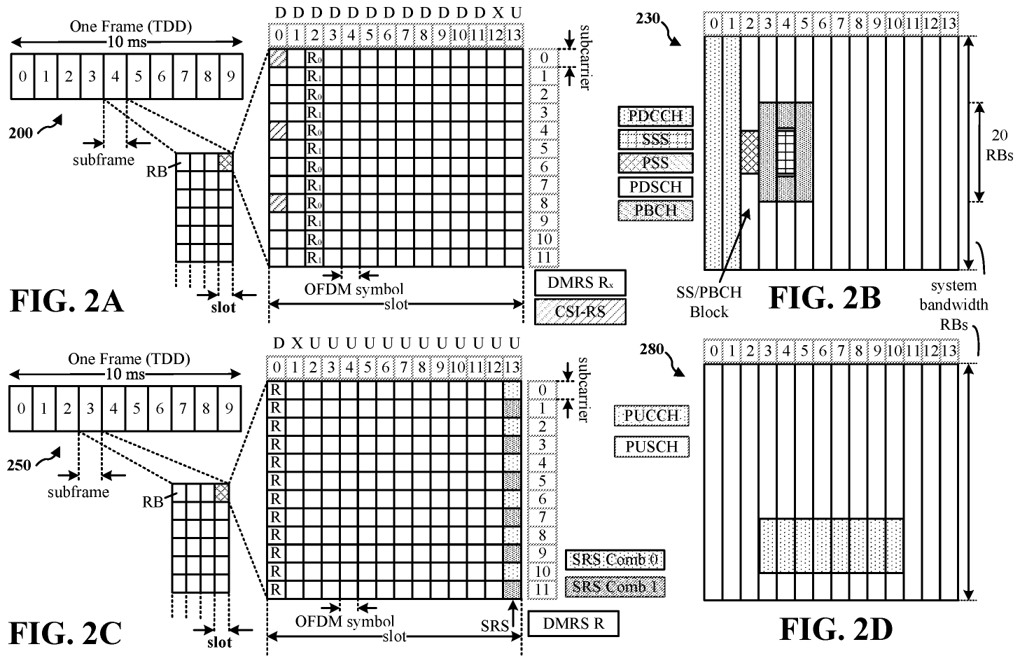

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively.

Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols.

The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used.

The UE may transmit sounding reference signals (SRS). An SRS resource set configuration may define resources for SRS transmission. For example, as illustrated, an SRS configuration may specify that SRS may be transmitted in the last symbol of a subframe. The SRS may have a comb structure, and a UE may transmit SRS on one comb for each SRS port. The SRS may be used by a base station for channel quality estimation to enable frequency-dependent scheduling on the UL. The SRS may also be used for channel estimation to select a precoder for downlink MIMO.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

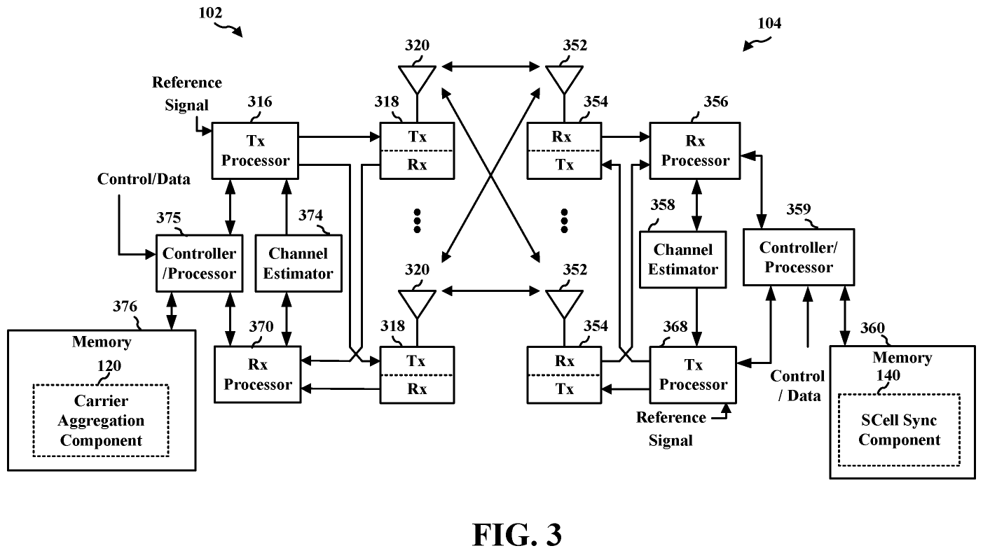

FIG. 3 is a diagram of an example of a base station 102 and a UE 104 in an access network. The UE 104 may be an example of a receiving device. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 104. Each spatial stream may be provided to a different antenna 320 via a separate transmitter 318Tx. Each transmitter 318Tx may modulate an RF carrier with a respective spatial stream for transmission.

At the UE 104, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 104. If multiple spatial streams are destined for the UE 104, they may be combined by the Rx processor 356 into a single OFDM symbol stream. The Rx processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are decoded and deinterleaved to recover the data and control signals that were originally transmitted by the base station 102 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 102, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 102 in a manner similar to that described in connection with the receiver function at the UE 104. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK or NACK protocol to support HARQ operations.

At least one of the Tx processor 368, the Rx processor 356, and the controller/processor 359 may be configured to perform aspects in connection with the SCell sync component 140 of FIG. 1. For example, the memory 360 may include executable instructions defining the SCell sync component 140. The Tx processor 368, the Rx processor 356, and/or the controller/processor 359 may be configured to execute the SCell sync component 140.

At least one of the Tx processor 316, the Rx processor 370, and the controller/processor 375 may be configured to perform aspects in connection with the carrier aggregation component 120 of FIG. 1. For example, the memory 376 may include executable instructions defining the carrier aggregation component 120. The Tx processor 316, the Rx processor 370, and/or the controller/processor 375 may be configured to execute the carrier aggregation component 120.

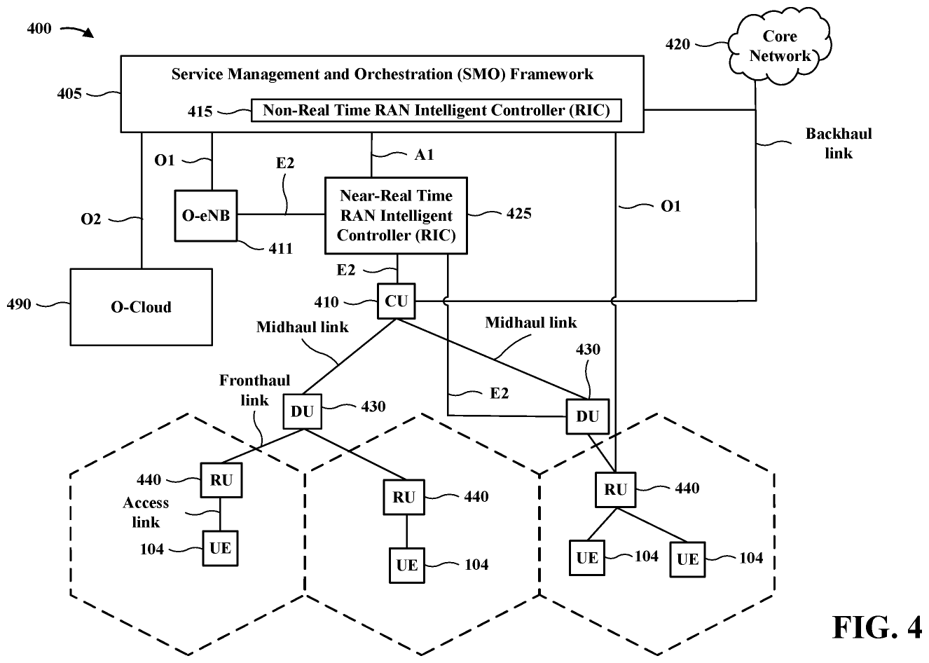

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

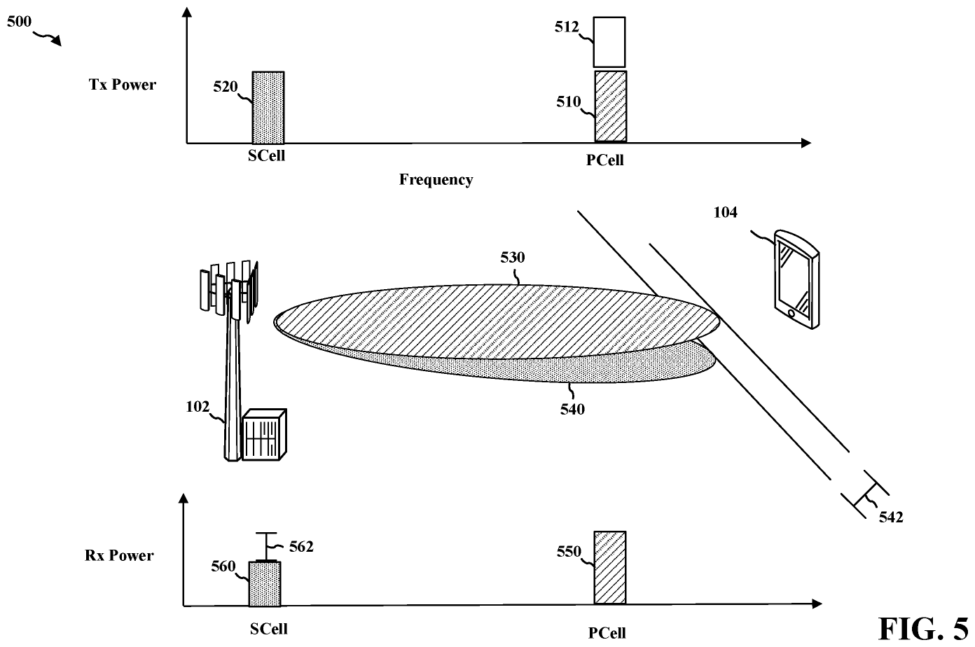

FIG. 5 is a diagram 500 illustrating an example of beam squinting in inter-band carrier aggregation. In carrier aggregation, the PCell may transmit with a same transmission power 510 as the transmission power 520 for the SCell. The PCell may also transmit an SSB 512. By foregoing transmission of the SSB on the SCell, the base station 102 may conserve power. The lack of SSB on the SCell, however, implies that beam management for the SCell is based on the SSB 512 (or other RS such as CSI-RS) of the PCell. That is, the carrier aggregation uses common beam management (CBM) for the PCell and the SCell.

In an aspect, beam squinting occurs due to separation in frequency between the reference signal on the PCell and the channel of the SCell. That is, the base station 102 transmits a beam 530 for the PCell using the beam selected based on the SSB 512. The beam 530 may be updated as needed based on periodic transmission of the SSB 512. The base station 102 transmits a beam 540 for the SCell. Because there is no SSB transmitted on the frequency of the SCell, however, the beam 540 may deviate from the beam 530, for example, due to different channel conditions at the different frequencies. The different beams 530 and 540 may result in a difference in antenna gain 542. Generally, the beam 540 for the SCell will experience lower antenna gain than the beam 530 for the PCell. At the UE, the difference in antenna gain results in a difference 562 between a received power 560 for the SCell and a received power 550 for the PCell. The difference 562 may reduce the feasibility of inter-band CA for SSB-less cells.

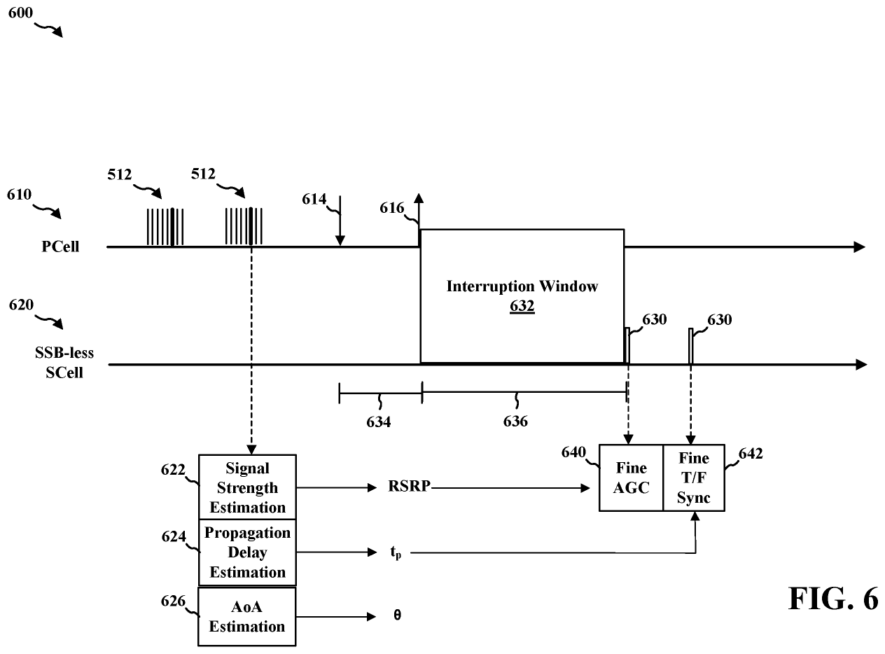

FIG. 6 is a diagram illustrating a first example procedure 600 for synchronization with a SSB-less SCell. A UE 104 may initially be connected to a PCell 610, which may periodically transmit SSBs 512. The SSBs 512 may be transmitted on different beams, allowing the UE 104 to identify a best beam. The SSBs 512 may also be used for measurements and maintaining time and frequency tracking loops.

The base station 102 may activate the SSB-less SCell 620 by transmitting a MAC-CE 614 on the PCell 610. The MAC-CE 614 may include a trigger for an A-TRS 630. The UE 104 may acknowledge the MAC-CE 614 by transmitting a HARQ-ACK 616. The UE 104 may transmit the HARQ-ACK 616 after a HARQ delay 634. In an aspect, the timing of the A-TRS 630 may be based on an interruption window 632 measured from the HARQ-ACK 616. The interruption window 632 may represent a time period when the UE 104 cannot use the same hardware (e.g., receive chain) as used for the PCell for the SCell. For instance, the UE 104 may tune the hardware for the different frequency band during the interruption window 632. A duration 636 of the interruption window 632 may be based on a MAC processing time (e.g., 3 ms). The base station 102 may start transmission of the A-TRS 630 at the end of the interruption window 632.

In an aspect, the UE 104 may synchronize to the SCell 620 based on both the A-TRS 630 and estimates according to measurements of the PCell. For example, the UE 104 may perform a signal strength estimation 622, propagation delay estimation 624, and/or an angle of arrival (AoA) estimation 626 based on the SSB 512. The signal strength estimation 622 may be based on a measurement of signal strength (e.g., reference signal received power (RSRP)) of the SSB 512. In an aspect, the estimated signal strength may be used for course AGC for the SCell 620.

The propagation delay estimation 624 may output a propagation time (tₚ) for the PCell 610. The timing for the SCell 620 may be within a timing error (t_{ε}) of the tₚ. The t_{ε} may be based on a distance between the UE 104 and the base station 102 that provides the PCell 610 and the SCell 620. For example, the UE 104 may estimate t_{ε} based on the RSRP from the signal strength estimation 622. In another example, the UE 104 may estimate the t_{ε} based on a propagation delay for the distance between the UE 104 and the base station 102, for example, using a formula or look up table. Alternatively, the UE 104 may receive a value of the t_{ε} from the PCell 610. For instance, the PCell 610 may calculate a maximum value of the t_{ε} based on a size of the SCell 620.

The AoA estimation 626 may be based on the receive beam of the PCell 610. For example, the AoA estimation 626 may be based on the SSB or the CSI-RS that is closer in time to an activation of the secondary cell (e.g., MAC-CE 614). The AoA estimation 626 may output an angle θ. In an aspect, the AoA of the SCell 620 may be within angle δ of the AoA.

When the UE 104 receives the A-TRS 630, the UE 104 may perform fine AGC 640 and fine time/frequency (T/F) synchronization 642 based on the A-TRS 630 and the signal strength estimation 622, propagation delay estimation 624, and/or AoA estimation 626. For instance, the fine AGC 640 may be based on the RSRP from the signal strength estimation 622 and a first slot of the A-TRS 630. The fine T/F synchronization 642 may be based on the tₚ and a second slot of the A-TRS 630.

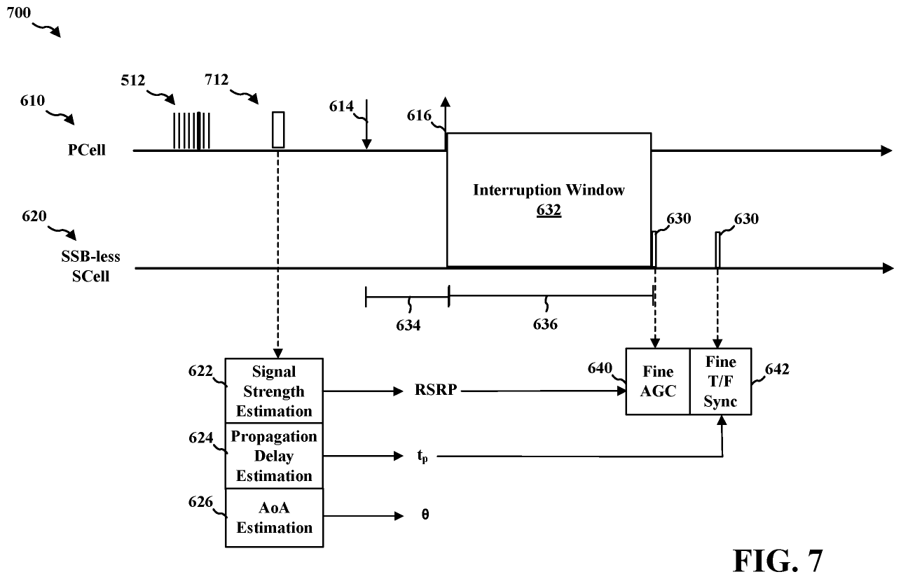

FIG. 7 is a diagram illustrating a second example procedure 700 for synchronization with the SSB-less SCell 620. The procedure 700 may be similar to the procedure 600 except the UE 104 may receive a CSI-RS 712 from the PCell 610. The signal strength estimation 622, propagation delay estimation 624, and/or AoA estimation 626 may be based on the CSI-RS 712 instead of the SSB 512. In an aspect, the UE 104 may perform the procedure 600 or the procedure 700 based on whether the SSB 512 or the CSI-RS is received closer in time to the MAC-CE 614.

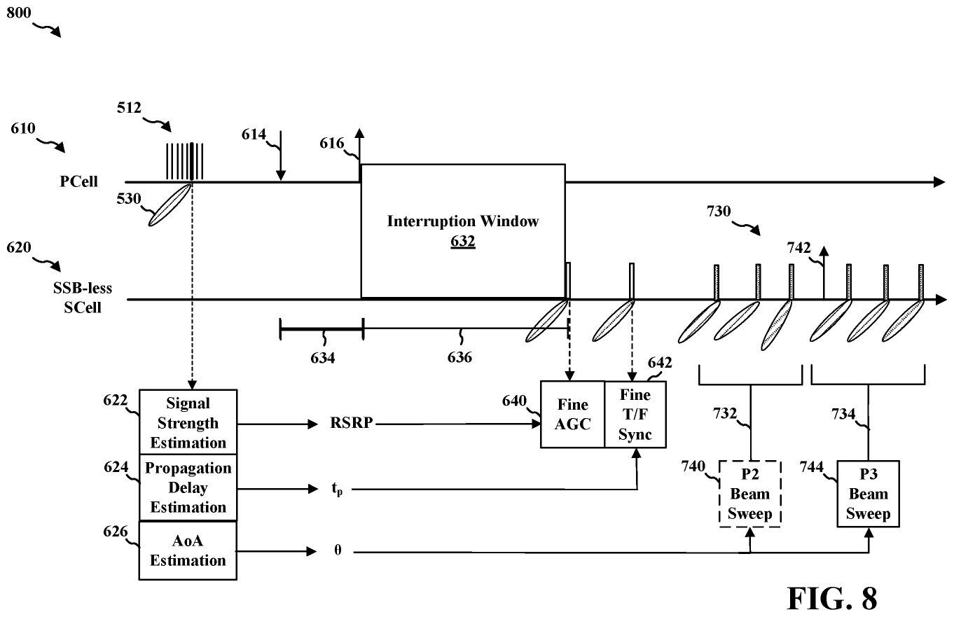

FIG. 8 is a diagram illustrating a third example procedure 800 for synchronization with the SSB-less SCell 620. The procedure 800 may be similar to the procedure 600 and the procedure 700 with the addition of additional beam sweeping. For example, additional beam sweeping may address the problem of beam squinting by allowing the UE 104 to adjust a receive beam. In some implementations, transmit beam sweeping may be used to change a transmit beam 540 for the SCell 620 (e.g., to be different than the beam 530). The beam sweeping may be limited by the angle δ for faster beam acquisition.

In an aspect, the SCell 620 may transmit a CSI-RS 730 for beam acquisition. In some implementations, the CSI-RS 730 may include a first burst 732 on different beams and a second burst 734 on the same beam. The first burst 732 may be used for P2 beam sweeping of the transmit beam. That is, the SCell 620 may sweep the first burst 732 around the beam 530 for the PCell 610 (e.g., by transmitting on beams within the angle δ of the beam 530). The UE 104 may perform P2 beam sweep 740 by selecting a beam based on the first burst 732. The UE 104 may indicate the selected beam, for example, by transmitting a MAC-CE 742.

In an aspect, the SCell 620 may transmit the second burst 734 on the same beam. The UE 104 may perform the P3 beam sweep 744 by receiving each beam of the second burst 734 with a different receive beam. In an aspect, the receive beams may be within a range [θ−6, θ+6]. The number NZP-CSI-RS resources for the second burst 734 may be based on the angle δ. The UE 104 may select the best receive beam for the SCell 620.

In some implementations, the UE 104 may have a single Rx chain. In such cases, the UE 104 may not be able to measure the PCell 610 when tuned to the SCell 620. The UE 104 may be configured with CSI-RS measurements (e.g., layer 3 measurement objects) for mobility. Accordingly, the UE 104 may measure a CSI-RS 730 from the SCell 620 for mobility purposes without switching back to the PCell 610. In cases where the UE 104 does switch back to the PCell 610 (e.g., to measure the SSB 512), the UE 104 may perform the P2 beam sweep 740 and/or the P3 beam sweep 744 upon returning to the SCell 620.

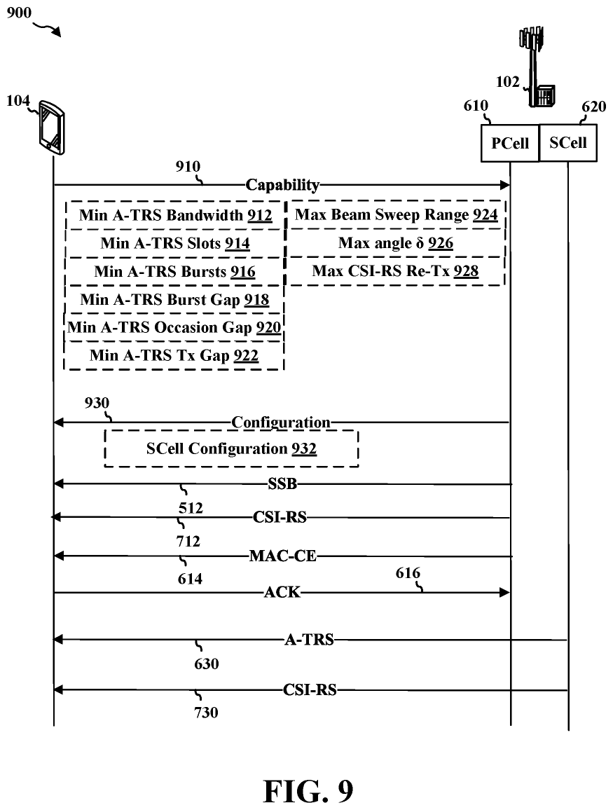

FIG. 9 is a message diagram 900 illustrating example messages between a base station 102 and a UE 104. The UE 104 may be an example of a UE 104 including the SCell sync component 140. The base station 102 may include the carrier aggregation component 120. The base station 102 may provide the PCell 610 and the PCell 610 on different frequency bands.

The UE 104 may transmit a capability message 910 to the base station 102. For example, the capability message 910 may be a RRC message. The capability message 910 may indicate, for example, that the UE 104 is capable of synchronizing with a secondary cell based on measurements of the primary cell. In some implementations, the capability message 910 indicates an ability of the UE to acquire a beam of the secondary cell. The capability of the UE 104 may be based on characteristics of the A-TRS 630 and/or a beam sweeping procedure. For example, the capability message 910 may indicate an ability of the UE to synchronize with the secondary cell based on one or more of: a minimum bandwidth of the A-TRS 912; a minimum number of slots per burst of the A-TRS 914; a minimum number of bursts of the A-TRS 916; a minimum slot gap between bursts of the A-TRS 918; a minimum time gap between transmission occasions of the A-TRS 920; or a maximum time gap between a last burst of the A-TRS and a transmission for the UE on the secondary cell 922. As another example, the capability message 910 may indicate an ability of the UE to acquire a beam of the secondary cell based on one or more of: a maximum range of the receive beam sweep 924; a maximum offset angle δ from the AoA for the receive beam sweep 926; or a maximum number of retransmissions of the CSI-RS from the secondary cell for the receive beam sweep 928.

The base station 102 may transmit a configuration 930 from the PCell 610. The configuration 930 may be, for example, an RRC message. For example, the configuration 930 may include a SCell configuration 932 for the SCell 620. In some implementations, the SCell configuration 932 may configure properties of the A-TRS 630 and/or a CSI-RS 730.

The base station 102 and the UE 104 may exchange reference signals and messages as discussed above with respect to FIGS. 6-8 to perform one of the procedures 600, 700, or 800. For example, the base station 102 may transmit the SSB 512, the CSI-RS 712, and the MAC-CE 614 on the PCell 610. The UE 104 may transmit the ACK 616. The base station 102 may transmit the A-TRS 630 and the CSI-RS 730 on the SCell 620.

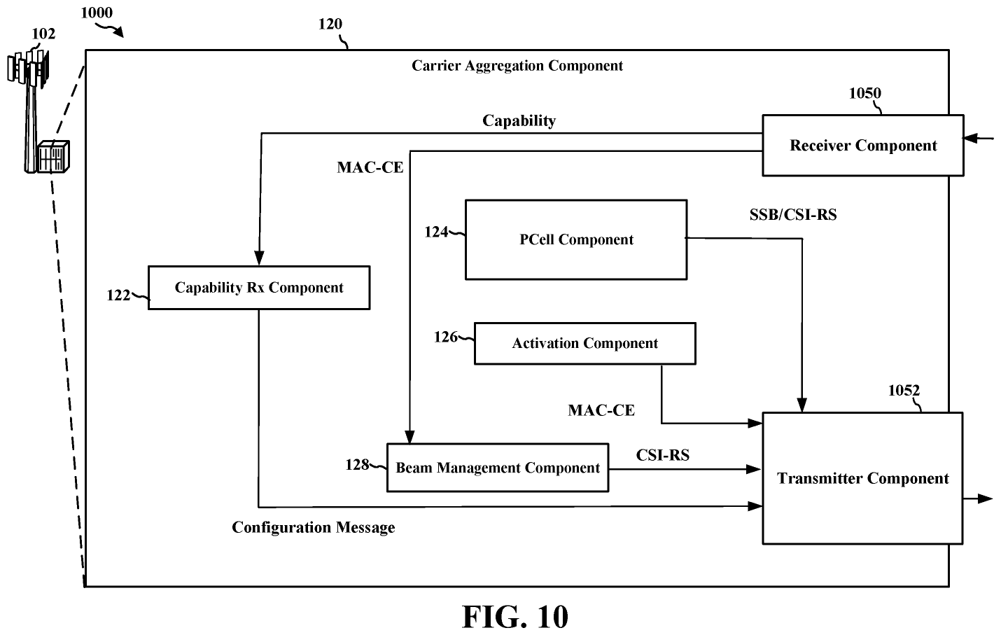

FIG. 10 is a conceptual data flow diagram 1000 illustrating the data flow between different means/components in an example base station 102, which may be an example of the base station 102 including the carrier aggregation component 120. The carrier aggregation component 120 may be implemented by the memory 376 and the Tx processor 316, the Rx processor 370, and/or the controller/processor 375 of FIG. 3. For example, the memory 376 may store executable instructions defining the carrier aggregation component 120 and the Tx processor 316, the Rx processor 370, and/or the controller/processor 375 may execute the instructions.

The base station 102 may include a receiver component 1050, which may include, for example, a radio frequency (RF) receiver for receiving the signals described herein. The base station 102 may include a transmitter component 1052, which may include, for example, an RF transmitter for transmitting the signals described herein. In an aspect, the receiver component 1050 and the transmitter component 1052 may co-located in a transceiver such as illustrated by the Tx/Rx 318 in FIG. 3.

As discussed with respect to FIG. 1, the carrier aggregation component 120 may include the capability Rx component 122, the PCell component 124, the activation component 126, and the beam management component 128.

The receiver component 1050 may receive UL signals from the UE 104 including the capability message 910 and the ACK 616. The receiver component 1050 may provide the capability message 910 to the capability Rx component 122. The receiver component 1050 may provide the ACK 616 to the activation component 126.

The capability Rx component 122 may be configured to receive, from the UE 104 via the receiver component 1050, an indication of a capability (e.g., capability message 910) to synchronize with a secondary cell based on measurements of a primary cell co-located with the secondary cell at the base station. For example, the capability Rx component 122 may receive the capability message 910 via the receiver component 1050. The capability Rx component 122 may determine whether to configure the UE 104 with the SSB-less SCell 620 based on the capability message 910. For example, if the SCell 620 can satisfy the minimum requirements indicated by the capability message 910, the SCell 620 may configure the UE 104 with the SCell 620. For instance, the SCell 620 may output the SCell configuration 932 via the transmitter component 1052.

The PCell component 124 may be configured to transmit a SSB or a CSI-RS from the primary cell. For example, the PCell component 124 may output the SSB 512 or the CSI-RS for transmission via the transmitter component 1052.

The activation component 126 may be configured to transmit a MAC-CE configured to activate the secondary cell. For example, the activation component 126 may obtain the SCell configuration 932 from the capability Rx component 122. The activation component 126 may generate the MAC-CE 614 to activate the SCell configuration 932 for the SCell 620. The activation component 126 may output the MAC-CE 614 for transmission via the transmitter component 1052. In some implementations, the activation component 126 may output the A-TRS 630 for transmission via the transmitter component 1052.

The beam management component 128 may be configured to transmit a burst of a CSI-RS with repetition on a same beam from the secondary cell for receive beam acquisition by the UE. For example, the beam management component 128 may output the second burst 734 of the CSI-RS 730 for transmission by the transmitter component 1052. In some implementations, the beam management component 128 may also output the first burst 732 of the CSI-RS 730 for transmission by the transmitter component 1052.

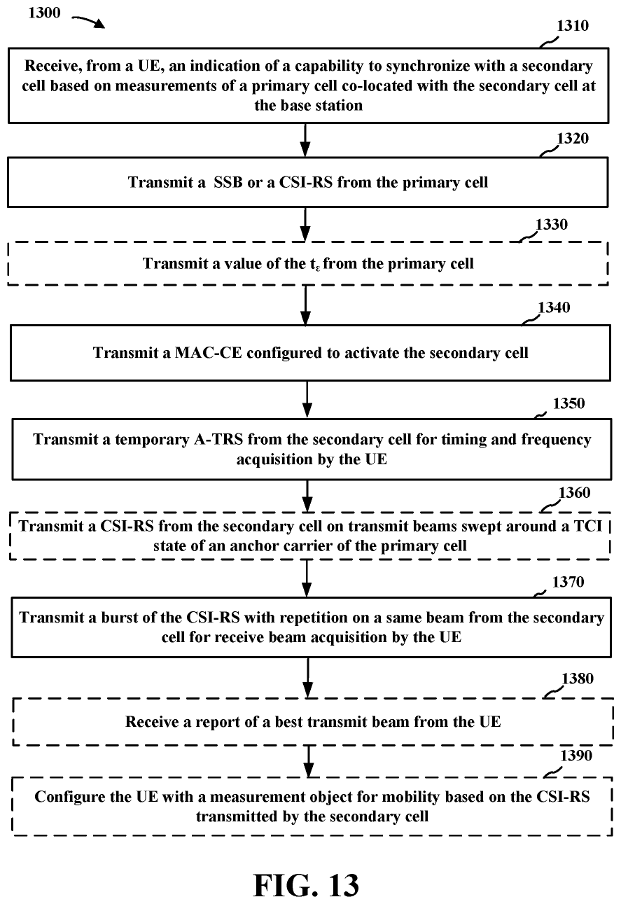

Various components of base station 102 may provide means for performing the methods described herein, including with respect to FIG. 13. In some examples, means for transmitting, outputting, or sending (or means for outputting for transmission) may include the transceivers 318TX and/or antenna(s) 320 of the base station 102 illustrated in FIG. 3 and/or the transmitter component 1052 of the base station 102 in FIG. 10. Means for receiving, obtaining, selecting, and updating may include the controller/processor 375, memory 376, and other various processors of FIG. 3 and/or the various components of FIG. 10 discussed above.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 10 is an example, and many other examples and configurations of the base station 102 are possible.

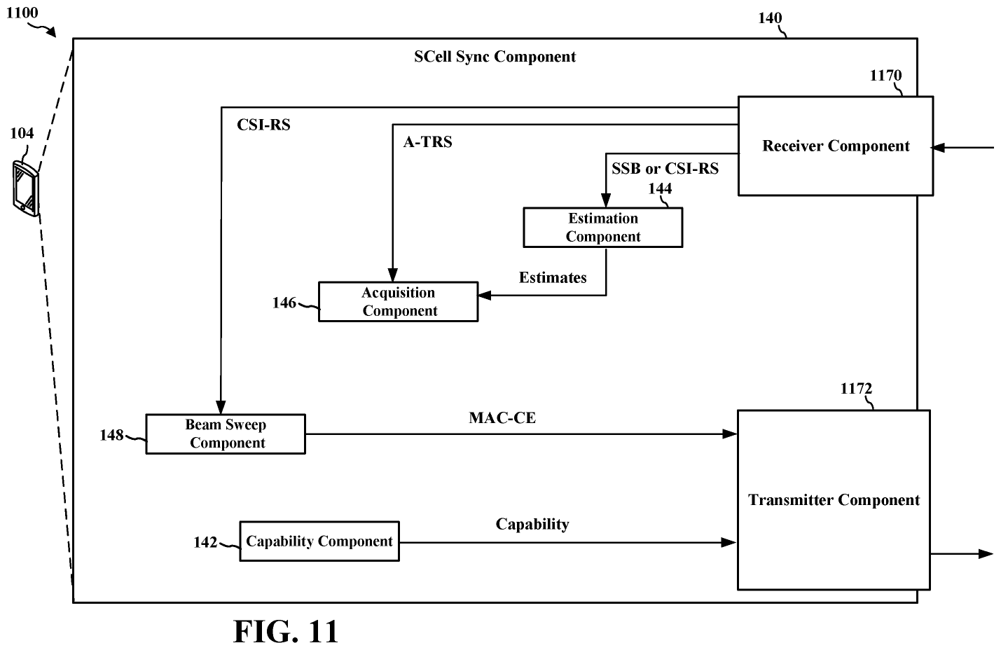

FIG. 11 is a conceptual data flow diagram 1100 illustrating the data flow between different means/components in an example UE 104, which may include the SCell sync component 140. The SCell sync component 140 may be implemented by the memory 360 and the Tx processor 368, the Rx processor 356, and/or the controller/processor 359.

For example, the memory 360 may store executable instructions defining the SCell sync component 140 and the Tx processor 368, the Rx processor 356, and/or the controller/processor 359 may execute the instructions.

The UE 104 may include a receiver component 1170, which may include, for example, a RF receiver for receiving the signals described herein. The UE 104 may include a transmitter component 1172, which may include, for example, an RF transmitter for transmitting the signals described herein. In an aspect, the receiver component 1170 and the transmitter component 1172 may co-located in a transceiver such as the Tx/Rx 352 in FIG. 3.

As discussed with respect to FIG. 1, the SCell sync component 140 may include the capability component 142, the estimation component 144, the acquisition component 146, and the beam sweep component 148.

The receiver component 1170 may receive DL signals described herein such as the configuration 930, the SSB 512, the CSI-RS 712, the MAC-CE 614, the A-TRS 630 and the CSI-RS 730. The receiver component 1170 may provide the SSB 512 or the CSI-RS 712 to the estimation component 144. The receiver component 1170 may provide the configuration 930, the MAC-CE 614, and the A-TRS 630 to the acquisition component 146. The receiver component 1170 may provide the CSI-RS 730 to the beam sweep component 148.

The capability component 142 may be configured to transmit, to a primary cell, an indication of a capability to synchronize with a secondary cell based on measurements of the primary cell. For example, the capability component 142 may output the capability message 910 for transmission via the transmitter component 1172. The capability component 142 may select the values of the capability message 910 based on the hardware and/or software capabilities of the UE 104.

The estimation component 144 may be configured to estimate the tₚ and the AoA of the SCell 620 based on the SSB 512 or the CSI-RS 712 transmitted by the PCell 610. For example, the estimation component 144 may obtain the SSB 512 or the CSI-RS 712 via the receiver component 1170. The estimation component 144 may perform the signal strength estimation 622, the propagation delay estimation 624, and/or the AoA estimation 626. The estimation component may output the RSRP, the tₚ, and/or the θ to the acquisition component 146.

The acquisition component 146 may be configured to perform AGC, fine timing acquisition, and fine frequency acquisition of the secondary cell based on the A-TRS 630 transmitted by the SCell 620. For example, the acquisition component 146 may obtain the A-TRS 630 from the receiver component 1170. The acquisition component 146 may perform the fine AGC 640 and/or the fine T/F synchronization 642.

The beam sweep component 148 may be configured to perform a receive beam sweep on a burst of a CSI-RS 730 transmitted by the SCell 620. The beam sweep component 148 may obtain the estimated AOA or θ from the estimation component 144. A range of the receive beam sweep is based on the estimated AOA or θ. That is, the beam sweep component 148 may configure the receiver component 1170 to receive each beam of the second burst 734 of the CSI-RS 730 with a different receive beam selected based on θ (e.g., in the range [θ−6, θ+6]). The beam sweep component 148 may configure the receiver component 1170 with the best receive beam for receiving transmissions from the SCell 620.

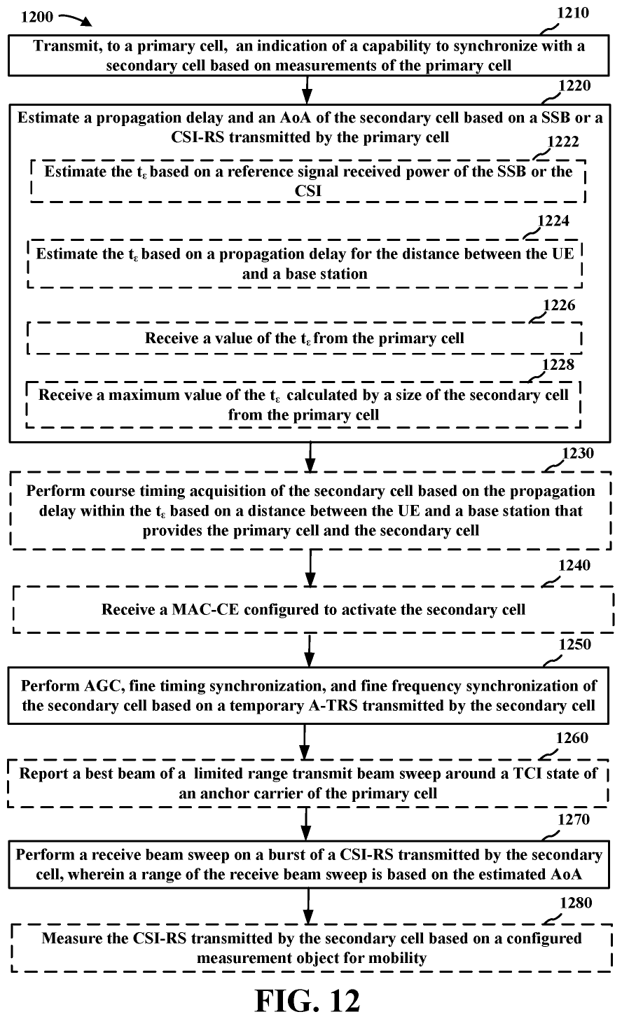

Various components of base station 102 may provide means for performing the methods described herein, including with respect to FIG. 12. In some examples, means for transmitting, outputting, or sending (or means for outputting for transmission) may include the transceivers 354TX and/or antenna(s) 352 of the UE 104 illustrated in FIG. 3 and/or the transmitter component 1172 of the UE 104 in FIG. 12. Means for measuring, generating, reporting, obtaining, selecting, and updating may include the controller/processor 359, memory 360, and other various processors of FIG. 3 and/or the various components of FIG. 11 discussed above.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 11 is an example, and many other examples and configurations of the UE 104 are possible.

FIG. 12 is a flowchart of an example method 1200 for a UE 104 to synchronize with a secondary cell. The method 1200 may be performed by a UE 104 (such as the UE 104, which may include the memory 360 and which may be the entire UE 104 or a component of the UE 104 such as the SCell sync component 140, Tx processor 368, the Rx processor 356, or the controller/processor 359). The method 1200 may be performed by the SCell sync component 140 in communication with the carrier aggregation component 120 of the base station 102. Optional blocks are shown with dashed lines.

At block 1210, the method 1200 includes transmitting, to a primary cell, an indication of a capability to synchronize with a secondary cell based on measurements of the primary cell. In some implementations, for example, the UE 104, the Tx processor 368 or the controller/processor 359 may execute the SCell sync component 140 or the capability component 142 to transmit, to a primary cell, an indication of a capability to synchronize with a secondary cell based on measurements of the primary cell. In some implementations, the secondary cell is configured not to transmit a SSB. In some implementations, the capability indicates an ability of the UE to synchronize with the secondary cell based on one or more of: a minimum bandwidth of the A-TRS; a minimum number of slots per burst of the A-TRS; a minimum number of bursts of the A-TRS; a minimum slot gap between bursts of the A-TRS; a minimum time gap between transmission occasions of the A-TRS; or a maximum time gap between a last burst of the A-TRS and a transmission for the UE on the secondary cell. In some implementations, the capability indicates an ability of the UE to acquire a beam of the secondary cell based on one or more of: a maximum range of the receive beam sweep; a maximum offset angle δ from the AoA for the receive beam sweep; or a maximum number of retransmissions of the CSI-RS from the secondary cell for the receive beam sweep. Accordingly, the UE 104, the Tx processor 368, or the controller/processor 359 executing the SCell sync component 140 or the capability component 142 may provide means for transmitting, to a primary cell, an indication of a capability to synchronize with a secondary cell based on measurements of the primary cell.

At block 1220, the method 1200 includes estimating a propagation delay and an AoA of the secondary cell based on a SSB or a CSI-RS transmitted by the primary cell. In some implementations, for example, the UE 104, the Rx processor 356 or the controller/processor 359 may execute the SCell sync component 140 or the estimation component 144 to estimate a tₚ and an AoA of the secondary cell based on a SSB or a CSI-RS transmitted by the primary cell. In some implementations, estimating the tₚ includes estimating the t_{ε}. In some implementations, at sub-block 1222, the block 1220 includes estimating the t_{ε} based on a reference signal received power of the SSB or the CSI. In some implementations, at sub-block 1224, the block 1220 includes estimating the t_{ε} based on a propagation delay for the distance between the UE and a base station. In some implementations, at sub-block 1226, the block 1220 includes receiving a value of the t_{ε} from the primary cell. In some implementations, at sub-block 1228, the block 1220 includes receiving a maximum value of the t_{ε} calculated by a size of the secondary cell from the primary cell. In some implementations, estimating the AoA is based on the SSB or the CSI-RS that is closer in time to an activation of the secondary cell. Accordingly, the UE 104, the Rx processor 356, or the controller/processor 359 executing the SCell sync component 140 or the estimation component 144 may provide means for estimating a propagation delay and an AoA of the secondary cell based on a SSB or a CSI-RS transmitted by the primary cell.

At block 1230, the method 1200 may optionally include performing course timing acquisition of the secondary cell based on the propagation delay within the t_{ε} based on a distance between the UE and a base station that provides the primary cell and the secondary cell. In some implementations, for example, the UE 104, the Rx processor 356 or the controller/processor 359 may execute the SCell sync component 140 or the acquisition component 146 to perform course timing acquisition of the secondary cell based on the propagation delay within the t_{ε} based on a distance between the UE and a base station that provides the primary cell and the secondary cell. Accordingly, the UE 104, the Rx processor 356, or the controller/processor 359 executing the SCell sync component 140 or the acquisition component 146 may provide means for performing course timing acquisition of the secondary cell based on the propagation delay within the t_{ε} based on a distance between the UE and a base station that provides the primary cell and the secondary cell.

At block 1240, the method 1200 may optionally include receiving a MAC-CE configured to activate the secondary cell. In some implementations, for example, the UE 104, the Rx processor 356 or the controller/processor 359 may execute the SCell sync component 140 or the acquisition component 146 to receive a MAC-CE configured to activate the secondary cell. A timing of the temporary A-TRS is based on an interruption window following an acknowledgment of the MAC-CE and the course timing acquisition. Accordingly, the UE 104, the Rx processor 356, or the controller/processor 359 executing the SCell sync component 140 or the acquisition component 146 may provide means for receiving a MAC-CE configured to activate the secondary cell.

At block 1250, the method 1200 includes performing AGC, fine timing synchronization, and fine frequency synchronization of the secondary cell based on a temporary A-TRS transmitted by the secondary cell. In some implementations, for example, the UE 104, the Rx processor 356 or the controller/processor 359 may execute the SCell sync component 140 or the acquisition component 146 to perform AGC, fine timing synchronization, and fine frequency synchronization of the secondary cell based on a temporary A-TRS transmitted by the secondary cell. In some implementations, the A-TRS is at least QCL Type D with the SSB or the CSI-RS transmitted by the primary cell. Accordingly, the UE 104, the Rx processor 356, or the controller/processor 359 executing the SCell sync component 140 or the acquisition component 146 may provide means for performing AGC, fine timing synchronization, and fine frequency synchronization of the secondary cell based on a temporary A-TRS transmitted by the secondary cell.

At block 1260, the method 1200 may optionally include reporting a best beam of a limited range transmit beam sweep around a TCI state of an anchor carrier of the primary cell. In some implementations, for example, the UE 104, the Tx processor 368 or the controller/processor 359 may execute the SCell sync component 140 or the acquisition component 146 to report a best beam of a limited range transmit beam sweep around a TCI state of an anchor carrier of the primary cell. Accordingly, the UE 104, the Tx processor 368, or the controller/processor 359 executing the SCell sync component 140 or the beam sweep component 148 may provide means for reporting a best beam of a limited range transmit beam sweep around a TCI state of an anchor carrier of the primary cell.

At block 1270, the method 1200 includes performing a receive beam sweep on a burst of a CSI-RS transmitted by the secondary cell, wherein a range of the receive beam sweep is based on the estimated AoA. In some implementations, for example, the UE 104, the Rx processor 356 or the controller/processor 359 may execute the SCell sync component 140 or the beam sweep component 148 to a receive beam sweep on a burst of a CSI-RS transmitted by the secondary cell, wherein a range of the receive beam sweep is based on the estimated AoA. For example, the range of the receive beam sweep may be from an angle δ less than the AoA to the angle δ greater than the AoA. In some implementations, a number of repetitions in the burst of the CSI-RS transmitted by the secondary cell is based on the angle δ. In some implementations, the CSI-RS transmitted by the secondary cell is QCL Type A with the A-TRS. Accordingly, the UE 104, the Rx processor 356, or the controller/processor 359 executing the SCell sync component 140 or the capability component 142 may provide means for performing a receive beam sweep on a burst of a CSI-RS transmitted by the secondary cell, wherein a range of the receive beam sweep is based on the estimated AoA.

At block 1280, the method 1200 may optionally include measuring the CSI-RS transmitted by the secondary cell based on a configured measurement object for mobility. In some implementations, for example, the UE 104, the Rx processor 356 or the controller/processor 359 may execute the SCell sync component 140 or the beam sweep component 148 to measuring the CSI-RS transmitted by the secondary cell based on a configured measurement object for mobility. Accordingly, the UE 104, the Rx processor 356, or the controller/processor 359 executing the SCell sync component 140 or the capability component 142 may provide means for measuring the CSI-RS transmitted by the secondary cell based on a configured measurement object for mobility.

In some implementations, the method 1200 may further optionally include switching a receive chain to the primary cell to receive the SSB; and performing another receive beam sweep on another burst of the CSI-RS transmitted by the secondary cell after switching the receive chain back to the secondary cell.

FIG. 13 is a flowchart of an example method 1300 for a base station to configure a UE for inter-band carrier aggregation. The method 1300 may be performed by a base station (such as the base station 102, which may include the memory 376 and which may be the entire base station 102 or a component of the base station 102 such as the carrier aggregation component 120, the Tx processor 316, the Rx processor 370, or the controller/processor 375). The method 1300 may be performed by the carrier aggregation component 120 in communication with the SCell sync component 140 of the UE 104.

At block 1310, the method 1300 includes receiving, from a UE, an indication of a capability to synchronize with a secondary cell based on measurements of a primary cell co-located with the secondary cell at the base station. In some implementations, for example, the base station 102, the Rx processor 370, or the controller/processor 375 may execute the carrier aggregation component 120 or the capability Rx component 122 to receive, from a UE, an indication of a capability to synchronize with a secondary cell based on measurements of a primary cell co-located with the secondary cell at the base station. In some implementations, the secondary cell is configured not to transmit a SSB. In some implementations, the capability indicates an ability of the UE to synchronize with the secondary cell based on one or more of: a minimum bandwidth of the A-TRS; a minimum number of slots per burst of the A-TRS; a minimum number of bursts of the A-TRS; a minimum slot gap between bursts of the A-TRS; a minimum time gap between transmission occasions of the A-TRS; or a maximum time gap between a last burst of the A-TRS and a transmission for the UE on the secondary cell. In some implementations, the capability indicates an ability of the UE to acquire a beam of the secondary cell based on one or more of: a maximum range of the receive beam sweep; a maximum offset angle δ from the AoA for the receive beam sweep; or a maximum number of retransmissions of the CSI-RS from the secondary cell for the receive beam sweep. Accordingly, the base station 102, the Rx processor 370, or the controller/processor 375 executing the carrier aggregation component 120 or the capability Rx component 122 may provide means for receiving, from a UE, an indication of a capability to synchronize with a secondary cell based on measurements of a primary cell co-located with the secondary cell at the base station.

At block 1320, the method 1300 includes transmitting a SSB or a CSI-RS from the primary cell. In some implementations, for example, the base station 102, the Tx processor 316, or the controller/processor 375 may execute the carrier aggregation component 120 or the PCell component 124 to transmit a SSB or a CSI-RS from the primary cell. Accordingly, the base station 102, the Tx processor 316, or the controller/processor 375 executing the carrier aggregation component 120 or the PCell component 124 may provide means for transmitting a SSB or a CSI-RS from the primary cell.

At block 1330, the method 1300 may optionally include transmitting a value of the t_{ε} from the primary cell. In some implementations, for example, the base station 102, the Tx processor 316, or the controller/processor 375 may execute the carrier aggregation component 120 or the PCell component 124 to transmit a value of the t_{ε} from the primary cell. In some implementations, the timing error t_{ε} is based on a distance between the UE and the base station. For example, the block 1330 may optionally include transmitting, from the primary cell, a maximum value of the t_{ε} calculated based on a size of the secondary cell. Accordingly, the base station 102, the Tx processor 316, or the controller/processor 375 executing the carrier aggregation component 120 or the PCell component 124 may provide means for transmitting a value of the t_{ε} from the primary cell.

At block 1340, the method 1300 includes transmitting a MAC-CE configured to activate the secondary cell. In some implementations, for example, the base station 102, the Tx processor 316, or the controller/processor 375 may execute the carrier aggregation component 120 or the activation component 126 to transmit a MAC-CE configured to activate the secondary cell. Accordingly, the base station 102, the Tx processor 316, or the controller/processor 375 executing the carrier aggregation component 120 or the activation component 126 may provide means for transmitting a MAC-CE configured to activate the secondary cell.

At block 1350, the method 1300 includes transmitting a temporary A-TRS from the secondary cell for timing and frequency acquisition by the UE. In some implementations, for example, the base station 102, the Tx processor 316, or the controller/processor 375 may execute the carrier aggregation component 120 or the activation component 126 to transmit a temporary A-TRS from the secondary cell for timing and frequency acquisition by the UE. In some implementations, the A-TRS is at least QCL Type D with the SSB or the CSI-RS transmitted by the primary cell. Accordingly, the base station 102, the Tx processor 316, or the controller/processor 375 executing the carrier aggregation component 120 or the capability Rx component 122 may provide means for transmitting a temporary A-TRS from the secondary cell for timing and frequency acquisition by the UE.

At block 1360, the method 1300 may optionally include transmitting a CSI-RS from the secondary cell on transmit beams swept around a TCI state of an anchor carrier of the primary cell. In some implementations, for example, the base station 102, the Tx processor 316, or the controller/processor 375 may execute the carrier aggregation component 120 or the beam management component 128 to transmit a CSI-RS from the secondary cell on transmit beams swept around a TCI state of an anchor carrier of the primary cell. In some implementations, the CSI-RS transmitted by the secondary cell is QCL Type A with the A-TRS. In some implementations, the block 1360 includes receiving a report of a best transmit beam from the UE. Accordingly, the base station 102, the Tx processor 316, or the controller/processor 375 executing the carrier aggregation component 120 or the beam management component 128 may provide means for transmitting a CSI-RS from the secondary cell on transmit beams swept around a TCI state of an anchor carrier of the primary cell.

At block 1370, the method 1300 includes transmitting a burst of the CSI-RS with repetition on a same beam from the secondary cell for receive beam acquisition by the UE. In some implementations, for example, the base station 102, the Tx processor 316, or the controller/processor 375 may execute the carrier aggregation component 120 or the beam management component 128 to transmit a burst of the CSI-RS with repetition on a same beam from the secondary cell for receive beam acquisition by the UE. In some implementations, a range of a receive beam sweep of the UE for receive beam acquisition on the secondary cell is from an AoA of the SSB or CSI-RS from the primary cell minus an offset angle δ to the AoA plus the angle δ. In some implementations, a number of repetitions in the burst of the CSI-RS transmitted by the secondary cell is based on the angle δ. Accordingly, the base station 102, the Tx processor 316, or the controller/processor 375 executing the carrier aggregation component 120 or the beam management component 128 may provide means for transmitting a burst of the CSI-RS with repetition on a same beam from the secondary cell for receive beam acquisition by the UE.

At block 1380, the method 1300 may optionally include receiving a report of a best transmit beam from the UE. In some implementations, for example, the base station 102, the Rx processor 370, or the controller/processor 375 may execute the carrier aggregation component 120 or the beam management component 128 to receive a report of a best transmit beam from the UE. Accordingly, the base station 102, the Rx processor 370, or the controller/processor 375 executing the carrier aggregation component 120 or the beam management component 128 may provide means for receiving a report of a best transmit beam from the UE.

At block 1390, the method 1300 may optionally include configuring the UE with a measurement object for mobility based on the CSI-RS transmitted by the secondary cell. In some implementations, for example, the base station 102, the Tx processor 316, or the controller/processor 375 may execute the carrier aggregation component 120 or the beam management component 128 to configure the UE with a measurement object for mobility based on the CSI-RS transmitted by the secondary cell. Accordingly, the base station 102, the Tx processor 316, or the controller/processor 375 executing the carrier aggregation component 120 or the beam management component 128 may provide means for configuring the UE with a measurement object for mobility based on the CSI-RS transmitted by the secondary cell.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

### Example Aspects

Clause 1. A method of wireless communication at a user equipment (UE), comprising: transmitting, to a primary cell, an indication of a capability to synchronize with a secondary cell based on measurements of the primary cell; estimating a propagation delay (tₚ) and an angle of arrival (AoA) of the secondary cell based on a synchronization signal block (SSB) or a channel state information reference signal (CSI-RS) transmitted by the primary cell; performing automatic gain control (AGC), fine timing synchronization, and fine frequency synchronization of the secondary cell based on a temporary aperiodic tracking reference signal (A-TRS) transmitted by the secondary cell; and performing a receive beam sweep on a burst of a CSI-RS transmitted by the secondary cell, wherein a range of the receive beam sweep is based on the estimated AoA.

Clause 2. The method of clause 1, further comprising performing course timing acquisition of the secondary cell based on the propagation delay within a timing error (t_{ε}) based on a distance between the UE and a base station that provides the primary cell and the secondary cell.

Clause 3. The method of clause 2, further comprising receiving a media access control (MAC) control element (CE) configured to activate the secondary cell, wherein a timing of the temporary A-TRS is based on an interruption window following an acknowledgment of the MAC-CE and the course timing acquisition.

Clause 4. The method of clause 2 or 3, wherein estimating the tₚ comprises estimating the t_{ε} based on a reference signal received power of the SSB or the CSI-RS.

Clause 5. The method of clause 2 or 3, wherein estimating the tₚ comprises estimating the t_{ε} based on a propagation delay for the distance between the UE and a base station.

Clause 6. The method of clause 2 or 3, wherein estimating the tₚ comprises receiving a value of the t_{ε} from the primary cell.

Clause 7. The method of clause 2 or 3, wherein estimating the tₚ comprises receiving a maximum value of the t_{ε} calculated by a size of the secondary cell from the primary cell.

Clause 8. The method of any of clauses 1-7, wherein the secondary cell is configured not to transmit a SSB.

Clause 9. The method of any of clauses 1-8, wherein the capability indicates an ability of the UE to synchronize with the secondary cell based on one or more of: a minimum bandwidth of the A-TRS; a minimum number of slots per burst of the A-TRS; a minimum number of bursts of the A-TRS; a minimum slot gap between bursts of the A-TRS; a minimum time gap between transmission occasions of the A-TRS; or a maximum time gap between a last burst of the A-TRS and a transmission for the UE on the secondary cell.

Clause 10. The method of any of clauses 1-9, wherein the A-TRS is at least quasi-co-located (QCL) Type D with the SSB or the CSI-RS transmitted by the primary cell.

Clause 11. The method of any of clauses 1-10, wherein the CSI-RS transmitted by the secondary cell is QCL Type A with the A-TRS.

Clause 12. The method of any of clauses 1-11, wherein the range of the receive beam sweep is from an angle δ less than the AoA to the angle δ greater than the AoA.

Clause 13. The method of clause 12, wherein a number of repetitions in the burst of the CSI-RS transmitted by the secondary cell is based on the angle δ.

Clause 14. The method of any of clauses 1-13, wherein estimating the AoA is based on the SSB or the CSI-RS that is closer in time to an activation of the secondary cell.

Clause 15. The method of any of clauses 1-14, further comprising reporting a best beam of a limited range transmit beam sweep around a transmission configuration indicator (TCI) state of an anchor carrier of the primary cell.

Clause 16. The method of any of clauses 1-15, wherein the capability indicates an ability of the UE to acquire a beam of the secondary cell based on one or more of: a maximum range of the receive beam sweep; a maximum offset angle δ from the AoA for the receive beam sweep; or a maximum number of retransmissions of the CSI-RS from the secondary cell for the receive beam sweep.

Clause 17. The method of any of clauses 1-16, further comprising measuring the CSI-RS transmitted by the secondary cell based on a configured measurement object for mobility.

Clause 18. The method of claim any of clauses 1-17, further comprising: switching a receive chain to the primary cell to receive the SSB; and performing another receive beam sweep on another burst of the CSI-RS transmitted by the secondary cell after switching the receive chain back to the secondary cell.

Clause 19. A method of wireless communication at a base station, comprising: receiving, from a user equipment (UE), an indication of a capability to synchronize with a secondary cell based on measurements of a primary cell co-located with the secondary cell at the base station; transmitting a synchronization signal block (SSB) or a channel state information reference signal (CSI-RS) from the primary cell; transmitting a media access control (MAC) control element (CE) configured to activate the secondary cell; transmitting a temporary aperiodic tracking reference signal (A-TRS) from the secondary cell for timing and frequency acquisition by the UE, wherein a timing of the temporary A-TRS is based on an interruption window following an acknowledgment of the MAC-CE and a timing error (t_{ε}) between the primary cell and the secondary cell; and transmitting a burst of a CSI-RS with repetition on a same beam from the secondary cell for receive beam acquisition by the UE.

Clause 20. The method of clause 19, wherein the t_{ε} is based on a distance between the UE and the base station.

Clause 21. The method of clause 19, further comprising transmitting a value of the t_{ε} from the primary cell.

Clause 22. The method of clause 19, further comprising transmitting, from the primary cell, a maximum value of the t_{ε} calculated based on a size of the secondary cell.

Clause 23. The method of any of clauses 19-22, wherein the secondary cell is configured not to transmit a synchronization signal block (SSB).

Clause 24. The method of any of clauses 19-23, wherein the capability indicates an ability of the UE to synchronize with the secondary cell based on one or more of: a minimum bandwidth of the A-TRS; a minimum number of slots per burst of the A-TRS; a minimum number of bursts of the A-TRS; a minimum slot gap between bursts of the A-TRS; a minimum time gap between transmission occasions of the A-TRS; or a maximum time gap between a last burst of the A-TRS and a transmission for the UE on the secondary cell.

Clause 25. The method of any of clauses 19-24, wherein the A-TRS is at least quasi-co-located (QCL) Type D with the SSB or the CSI-RS transmitted by the primary cell.

Clause 26. The method of any of clauses 19-25, wherein the CSI-RS transmitted by the secondary cell is QCL Type A with the A-TRS.

Clause 27. The method of any of clauses 19-26, wherein a range of a receive beam sweep of the UE for receive beam acquisition on the secondary cell is from an angle of arrival (AoA) of the SSB or CSI-RS from the primary cell minus an offset angle δ to the AoA plus the angle δ.

Clause 28. The method of clause 27, wherein a number of repetitions in the burst of the CSI-RS transmitted by the secondary cell is based on the angle δ.

Clause 29. The method of any of clauses 19-28, further comprising: transmitting the CSI-RS from the secondary cell on transmit beams swept around a transmission configuration indicator (TCI) state of an anchor carrier of the primary cell; and receiving a report of a best transmit beam from the UE.

Clause 30. The method of any of clauses 19-29, wherein the capability indicates an ability of the UE to acquire a beam of the secondary cell based on one or more of: a maximum range of a receive beam sweep on the CSI-RS from the secondary cell; a maximum offset angle S from an AoA for the receive beam sweep; or a maximum number of retransmissions of the CSI-RS from the secondary cell for the receive beam sweep.

Clause 31. The method of any of clauses 19-30, further comprising configuring the UE with a measurement object for mobility based on the CSI-RS transmitted by the secondary cell.

Clause 32. A user equipment (UE), comprising: one or more memories, individually or in combination, storing computer-executable instructions; and one or more processors, individually or in combination, configured to execute the instructions and cause the UE to: transmit, to a primary cell an indication of a capability to synchronize with a secondary cell based on measurements of the primary cell; estimate a propagation delay (tₚ) and an angle of arrival (AoA) of the secondary cell based on a synchronization signal block (SSB) or a channel state information reference signal (CSI-RS) transmitted by the primary cell; perform automatic gain control (AGC), fine timing synchronization, and fine frequency synchronization of the secondary cell based on a temporary aperiodic tracking reference signal (A-TRS) transmitted by the secondary cell; and perform a receive beam sweep on a burst of a CSI-RS transmitted by the secondary cell, wherein a range of the receive beam sweep is based on the estimated AoA.

Clause 33. The UE of clause 32, wherein the processor is configured to execute the instructions to cause the UE to perform the method of any of claims 2-18.

Clause 34. An apparatus for wireless communication for a base station, comprising: one or more memories, individually or in combination, storing computer-executable instructions; and one or more processors, individually or in combination, coupled to the memory and configured to execute the computer-executable instructions to cause the base station to: receive, from a user equipment (UE), an indication of a capability to synchronize with a secondary cell based on measurements of a primary cell co-located with the secondary cell at the base station; transmit, via the transceiver, a synchronization signal block (SSB) or a channel state information reference signal (CSI-RS) from the primary cell; transmit, via the transceiver, a media access control (MAC) control element (CE) configured to activate the secondary cell; transmit, via the transceiver, a temporary aperiodic tracking reference signal (A-TRS) from the secondary cell for timing and frequency acquisition by the UE, wherein a timing of the temporary A-TRS is based on an interruption window following an acknowledgment of the MAC-CE and a timing error (t_{ε}) between the primary cell and the secondary cell; and transmit, via the transceiver, a burst of a CSI-RS with repetition on a same beam from the secondary cell for receive beam acquisition by the UE.

Clause 35. The apparatus of clause 34, wherein the at least one processor is configured to execute the instructions to cause the base station to perform the method of any of claims 20-31.

Clause 36. An apparatus for wireless communication for a base station, comprising means for performing the method of any of clauses 1-18.

Clause 37. An apparatus for wireless communication for a base station, comprising means for performing the method of any of clauses 19-31.

Clause 38. A non-transitory computer-readable medium storing computer-executable instructions configured to cause a user equipment to perform the method of any of clauses 1-18.

Clause 39. A non-transitory computer-readable medium storing computer-executable instructions configured to cause a base station to perform the method of any of clauses 19-31.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
transmitting, to a primary cell, an indication of a capability to synchronize with a secondary cell based on measurements of the primary cell;
estimating a propagation delay (tₚ) and an angle of arrival (AoA) of the secondary cell based on a synchronization signal block (SSB) or a channel state information reference signal (CSI-RS) transmitted by the primary cell;
performing automatic gain control (AGC), fine timing synchronization, and fine frequency synchronization of the secondary cell based on a temporary aperiodic tracking reference signal (A-TRS) transmitted by the secondary cell; and
performing a receive beam sweep on a burst of a CSI-RS transmitted by the secondary cell, wherein a range of the receive beam sweep is based on the estimated AoA.

2. The method of claim 1, further comprising performing course timing acquisition of the secondary cell based on the propagation delay within a timing error (t_{ε}) based on a distance between the UE and a base station that provides the primary cell and the secondary cell.

3. The method of claim 2, further comprising receiving a media access control (MAC) control element (CE) configured to activate the secondary cell, wherein a timing of the temporary A-TRS is based on an interruption window following an acknowledgment of the MAC-CE and the course timing acquisition.

4. The method of claim 2, wherein estimating the tₚ comprises estimating the t_{ε} based on a reference signal received power of the SSB or the CSI-RS.

5. The method of claim 2, wherein estimating the tₚ comprises estimating the t_{ε} based on a propagation delay for the distance between the UE and the base station.

6. The method of claim 2, wherein estimating the tₚ comprises receiving a value of the t_{ε} from the primary cell.

7. The method of claim 2, wherein estimating the tₚ comprises receiving a maximum value of the t_{ε} calculated by a size of the secondary cell from the primary cell.

8. The method of claim 1, wherein the secondary cell is configured not to transmit a SSB.

9. The method of claim 1, wherein the capability indicates an ability of the UE to synchronize with the secondary cell based on one or more of:
a minimum bandwidth of the A-TRS;
a minimum number of slots per burst of the A-TRS;
a minimum number of bursts of the A-TRS;
a minimum slot gap between bursts of the A-TRS;
a minimum time gap between transmission occasions of the A-TRS; or
a maximum time gap between a last burst of the A-TRS and a transmission for the UE on the secondary cell.

10. The method of claim 1, wherein the A-TRS is at least quasi-co-located (QCL) Type D with the SSB or the CSI-RS transmitted by the primary cell.

11. The method of claim 1, wherein the CSI-RS transmitted by the secondary cell is QCL Type A with the A-TRS.

12. The method of claim 1, wherein the range of the receive beam sweep is from an angle δ less than the AoA to the angle δ greater than the AoA.

13. The method of claim 12, wherein a number of repetitions in the burst of the CSI-RS transmitted by the secondary cell is based on the angle δ.

14. The method of claim 1, wherein estimating the AoA is based on the SSB or the CSI-RS that is closer in time to an activation of the secondary cell.

15. The method of claim 1, further comprising reporting a best beam of a limited range transmit beam sweep around a transmission configuration indicator (TCI) state of an anchor carrier of the primary cell.

16. The method of claim 1, wherein the capability indicates an ability of the UE to acquire a beam of the secondary cell based on one or more of:
a maximum range of the receive beam sweep;
a maximum offset angle δ from the AoA for the receive beam sweep; or
a maximum number of retransmissions of the CSI-RS from the secondary cell for the receive beam sweep.

17. The method of claim 1, further comprising measuring the CSI-RS transmitted by the secondary cell based on a configured measurement object for mobility.

18. The method of claim 1, further comprising:
switching a receive chain to the primary cell to receive the SSB; and
performing another receive beam sweep on another burst of the CSI-RS transmitted by the secondary cell after switching the receive chain back to the secondary cell.

19. A method of wireless communication at a base station, comprising:
receiving, from a user equipment (UE), an indication of a capability to synchronize with a secondary cell based on measurements of a primary cell co-located with the secondary cell at the base station;
transmitting a synchronization signal block (SSB) or a channel state information reference signal (CSI-RS) from the primary cell;
transmitting a media access control (MAC) control element (CE) configured to activate the secondary cell;
transmitting a temporary aperiodic tracking reference signal (A-TRS) from the secondary cell for timing and frequency acquisition by the UE, wherein a timing of the temporary A-TRS is based on an interruption window following an acknowledgment of the MAC-CE and a timing error (t_{ε}) between the primary cell and the secondary cell; and
transmitting a burst of a CSI-RS with repetition on a same beam from the secondary cell for receive beam acquisition by the UE.

20. The method of claim 19, further comprising transmitting a value of the t_{ε} from the primary cell or a maximum value of the t_{ε} calculated based on a size of the secondary cell.

21. The method of claim 19, wherein the secondary cell is configured not to transmit a synchronization signal block (SSB).

22. The method of claim 19, wherein the capability indicates an ability of the UE to synchronize with the secondary cell based on one or more of:
a minimum bandwidth of the A-TRS;
a minimum number of slots per burst of the A-TRS;
a minimum number of bursts of the A-TRS;
a minimum slot gap between bursts of the A-TRS;
a minimum time gap between transmission occasions of the A-TRS; or
a maximum time gap between a last burst of the A-TRS and a transmission for the UE on the secondary cell.

23. The method of claim 19, wherein the A-TRS is at least quasi-co-located (QCL) Type D with the SSB or the CSI-RS transmitted by the primary cell.

24. The method of claim 19, wherein the CSI-RS transmitted by the secondary cell is QCL Type A with the A-TRS.

25. The method of claim 19, wherein a range of a receive beam sweep of the UE for receive beam acquisition on the secondary cell is from an angle of arrival (AoA) of the SSB or CSI-RS from the primary cell minus an offset angle δ to the AoA plus the angle δ.

26. The method of claim 19, further comprising:
transmitting the CSI-RS from the secondary cell on transmit beams swept around a transmission configuration indicator (TCI) state of an anchor carrier of the primary cell; and
receiving a report of a best transmit beam from the UE.

27. The method of claim 19, wherein the capability indicates an ability of the UE to acquire a beam of the secondary cell based on one or more of:
a maximum range of a receive beam sweep on the CSI-RS from the secondary cell;
a maximum offset angle δ from an AoA for the receive beam sweep; or
a maximum number of retransmissions of the CSI-RS from the secondary cell for the receive beam sweep.

28. The method of claim 19, further comprising configuring the UE with a measurement object for mobility based on the CSI-RS transmitted by the secondary cell.

29. A user equipment (UE), comprising:
one or more memories, individually or in combination, storing computer-executable instructions; and
one or more processors, individually or in combination, configured to execute the instructions and cause the UE to:
transmit, to a primary cell, an indication of a capability to synchronize with a secondary cell based on measurements of the primary cell;
estimate a propagation delay (tₚ) and an angle of arrival (AoA) of the secondary cell based on a synchronization signal block (SSB) or a channel state information reference signal (CSI-RS) transmitted by the primary cell;
perform automatic gain control (AGC), fine timing synchronization, and fine frequency synchronization of the secondary cell based on a temporary aperiodic tracking reference signal (A-TRS) transmitted by the secondary cell; and
perform a receive beam sweep on a burst of a CSI-RS transmitted by the secondary cell, wherein a range of the receive beam sweep is based on the estimated AoA.

30. An apparatus for wireless communication for a base station, comprising:
one or more memories, individually or in combination, storing computer-executable instructions; and
one or more processors, individually or in combination, configured to execute the instructions and cause the base station to:
receive, from a user equipment (UE), an indication of a capability to synchronize with a secondary cell based on measurements of a primary cell co-located with the secondary cell at the base station;
transmit a synchronization signal block (SSB) or a channel state information reference signal (CSI-RS) from the primary cell;
transmit a media access control (MAC) control element (CE) configured to activate the secondary cell;
transmit a temporary aperiodic tracking reference signal (A-TRS) from the secondary cell for timing and frequency acquisition by the UE, wherein a timing of the temporary A-TRS is based on an interruption window following an acknowledgment of the MAC-CE and a timing error (t_{ε}) between the primary cell and the secondary cell; and
transmit a burst of a CSI-RS with repetition on a same beam from the secondary cell for receive beam acquisition by the UE.
